(19) United States
(12) Patent Application Publication
(10) Pub. No.: US 2006/0005032 A1
(43) Pub. Date: Jan. 5, 2006

(54) Method and system for enabling trust-based authorization over a network

(76) Inventors: Adam Cain, Madison, WI (US); Craig R. Watkins, State College, PA (US); Jeremey Barrett, Sugar Land, TX (US)

Correspondence Address: DARBY & DARBY P.C., P.O. BOX 5257, NEW YORK, NY, 10150-6257, US

(21) Appl. No.: 10/868,390

(22) Filed: Jun. 15, 2004

(51) Int. Cl. H04K 1/00

(52) U.S. Cl. 713/182

(57) ABSTRACT

Method and devices are directed to managing access to a resource over a network. Upon receiving a request for access to the resource over the network, a resource controller determines a parameter associated with the request based on a query of the user and a scan of a client device associated with the request. The controller then applies an access control rule based, in part, on the parameter to determine a level of trust. Depending on the type of request, the resource controller may negotiate access to the resource with a resource server on behalf of the user and act as proxy in establishing the connection, if the request is permitted. A level of access to the resource may be determined based on the level of trust.

### FIELD OF THE INVENTION

The present invention relates generally to computer security, and more particularly, to authorizing a client for access to a resource over a network employing a trust-based system.

### BACKGROUND OF THE INVENTION

With the need for more secure communications, different types of security systems and measures have evolved over time for networking systems. A user may desire remote access to various enterprise network services from a multitude of network-capable devices. Each of these devices may be running different software at the time the user attempts access. This mix of software running on a given device may affect a type or level of trust that the enterprise network has in security of the device. A type of network access medium and network location may also affect the level of trust associated with the device. Furthermore, a remote user may be able to authenticate to the enterprise network in several ways, each type of authentication having a different implied level of security. These variations often lead to a problematic combination of security concerns for enterprise networks.

Therefore, there is a need in the industry for an improved method and system for authorizing a client. Thus, it is with respect to these considerations, and others, that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates one embodiment of a network system in which the present invention may be practiced;

FIG. 2 illustrates a functional block diagram of one embodiment of a network device that may be employed to perform the invention;

FIG. 3 illustrates a flow diagram generally showing a process for managing access to a resource according to one embodiment of the present invention;

FIG. 4 illustrates message flows involved in one embodiment of the present invention for sign-on authorization; and

FIG. 5 illustrates another embodiment of message flows, in accordance with the present invention for access to a resource over a network.

### DETAILED DESCRIPTION OF THE PREFERRED EMBODIMENT

The present invention is directed to addressing the above-mentioned shortcomings, disadvantages and problems, and will be understood by reading and studying the following specification.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a comprehensive framework for specifying and enforcing access control privileges based on at least one parameter that defines a trust bestowed upon a user. This framework may be particularly useful in a system that provides regulated access to a network service for a remote user that may use a variety of methods to authenticate to an enterprise network from a variety of client devices.

A type of authentication, a location of client device, a crytptographic protection of communication channel, and the like, may be useful in determining a type and level of trust the enterprise network has in the remote user at the time network services are requested. This trust can be the basis for access control enforcement performed by a controlling network device, such as a gateway, and the like. A resource controller, and the like, may be configured to support the framework for specifying access control privileges and restrictions based on a type and level of trust. The trust may be bestowed upon the user as a function of at least one parameter associated with the user's access request.

Illustrative Operating Environment

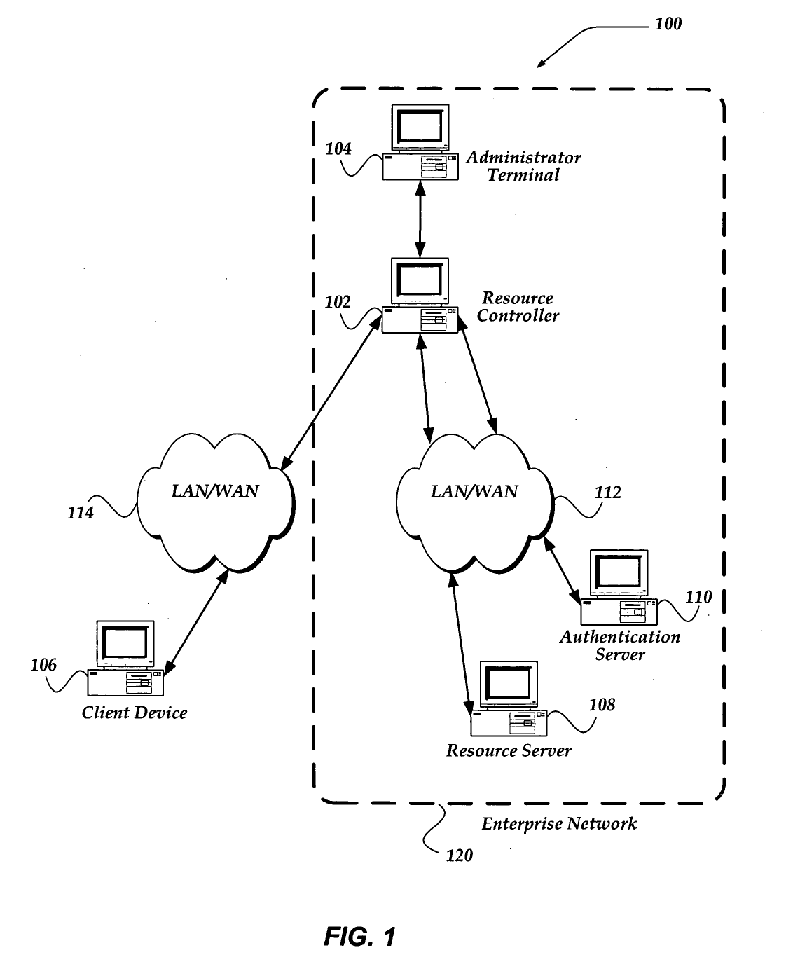

FIG. 1 illustrates one embodiment of network system 100, in which the present invention may be practiced. As will be described in more detail below, the present invention relates generally to authorizing a user. Network system 100 may include many more, or less, components than those shown, however, those shown are sufficient to disclose an illustrative environment for practicing the invention.

As shown in the figure, network system 100 includes Local Area Network/Wide Area Network's (LAN/WANs) 112 and 114, resource controller 102, administrator terminal 104, client device 106, resource server 108, and authentication server 110. Client device 106 and resource controller 102 are in communication over LAN/WAN 114. Authentication server 110 and resource server 108 are in communication with resource controller 102 over LAN/WAN 112. Administrator terminal 104 is coupled with resource controller 102.

LAN/WANs 112 and 114 are enabled to employ any form of computer readable media for communicating information from one electronic device to another. In addition, LAN/WANs 112 and 114 may include the Internet in addition to local area networks, wide area networks, direct channels, such as through a universal serial bus (USB) port, other forms of computer-readable media, and any combination thereof. On an interconnected set of LANs, including those based on differing architectures and protocols, a router acts as a link between LAN's, enabling messages to be sent from one to another. Also, communication links within LANs typically include twisted pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices may be remotely connected to either LANs or WANs via a modem and temporary telephone link. In essence LAN/WANs 112 and 114 may include any communication mechanism by which information may travel between network devices, such as client device 106 and resource controller 102, and the like.

Enterprise network 120 typically includes an intranet type network interconnecting resources and client devices within an enterprise. However, enterprise network 120 may also include network devices, such as authentication server 110, that may participate in the enterprise network through a secure connection over the Internet. Therefore, the term enterprise network may be construed to include a subset of network system 100, which may be managed by at least one network device, such as resource controller 102, and the like.

Resource controller 102 may be configured to communicate with client devices, servers, and other network resources. Resource controller 102 may be further configured to implement a comprehensive framework for specifying and enforcing access control privileges based on a parameter that defines a trust bestowed upon a user. Resource controller 102 may be in communication directly or over a LAN/WAN (not shown) with administrator terminal 104. Administrator terminal 104 may be employed to configure resource controller 102.

Resource controller 102 may be configured to operate as a server, a gateway, a portable or desktop computer with network connection, a firewall, a server array controller, a proxy server, and the like.

Client device 106 is any computing device with a network connection that a user may employ to access a resource within enterprise network 120. Resources to which access may be sought may reside on LAN/WAN 114 or on other LAN/WANs managed by resource controller 102, such as LAN/WAN 112. Resources may include an output device, such as a printer; an input device, such as a scanner; a storage device, such as a tape drive; a processing device, such as a server array; as well as web services, database services, email services, spreadsheet services, and the like.

Client device 106 may be configured to operate as a portable or desktop computer with a network connection, a personal digital assistant (PDA), and the like.

Resource server 108 may be any network device that is enabled to manage a resource on enterprise network 120. For example, resource server 108 may be a print server configured to manage a bank of printers, and the like. Resource server 108 may be configured to operate as a server, a gateway, a portable or desktop computer with a network connection, and the like.

Authentication server 110 may be any network device that is enabled to provide an authentication service over enterprise network 120. For example, authentication server 110 may be a third party certification authority configured to store authentication information associated with a client device 106. Authentication server 110 may be configured to operate as a server, a gateway, a portable or desktop computer with a network connection, and the like.

The invention, however, is not limited to the illustrated devices or configurations of FIG. 1. For example, client device 106 and resource controller 102 may be configured to operate in a peer-to-peer configuration, without departing from the spirit and the scope of the invention.

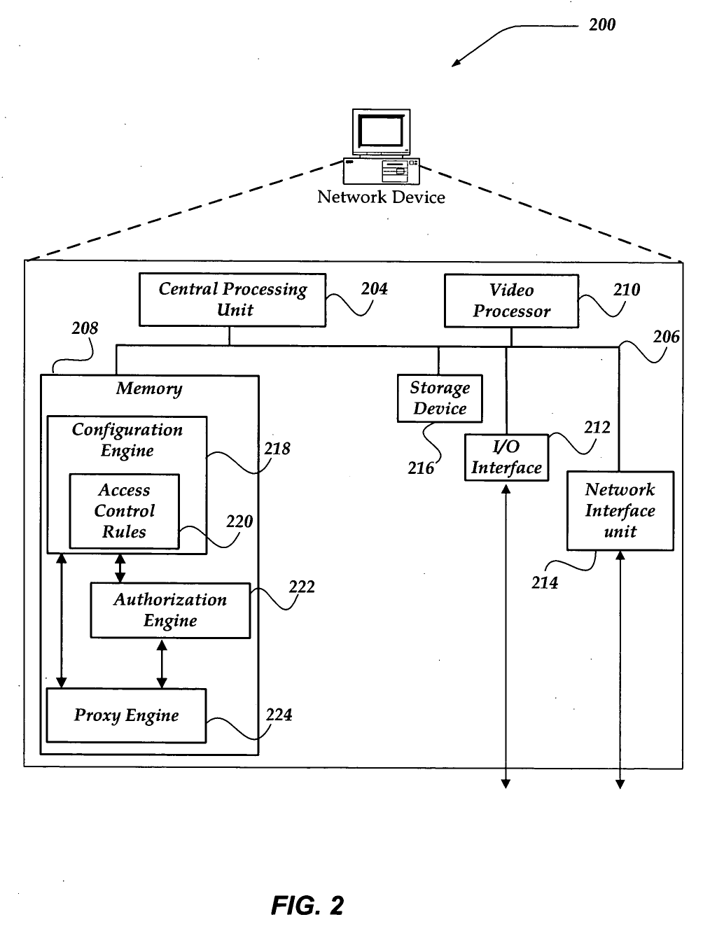

FIG. 2 illustrates a functional block diagram of one embodiment of network device 200 in which the present invention may be practiced. Network device 200 provides one embodiment for resource controller 102 of FIG. 1. It will be appreciated that not all components of network device 200 are illustrated, and that network device 200 may include more or less components than those shown in the figure. The communications may take place over a network, such as LAN/WANs 112 and 114 in FIG. 1, the Internet, or some other communications network.

As illustrated in FIG. 2, network device 200 includes central processing unit (CPU) 204, video processor 210, read only memory 208, memory 218, storage device 216, input/output interface (I/O) 212, and a network interface unit 214 interconnected via a bus 206.

In one embodiment, memory 218 may store program code for configuration engine 218, authorization engine 222, and proxy engine 224. Configuration engine 218 may include access control rules 220 that are employable to manage authorization of a user. Configuration engine 218 may be configured to store and update access control rules 220. Access control rules 220 may be configured by an administrator, and the like, and implement an access control policy for the enterprise network. Access control rules 220 may apply to a particular user, a resource, and the like. They may also be global in scope, applying to all users, resources, and the like. In one embodiment, access control rules 220 may be in an Action-Condition format. where Action may be “Allow”, “Deny”, and the like, and Condition may be a boolean expression including variable names and a possible value for each variable. Example access control rules of this format are as follows:

| Action | Condition |
|---|---|
| ALLOW | IF CLIENT IP = 10.1.2.3 |
| DENY | IF (USERNAME = “acain”) |

However, the invention is not limited to the above example. Other formats, structures, and the like may be employed.

Memory 218 may further include authorization engine 222. Authorization engine 222 may be configured to evaluate a request from the user for access and determine based, in part, on access control rules 220 whether the user may receive authorization to a requested resource. Proxy engine 224 may be configured to provide a proxy service for establishing a connection between a resource with enterprise network 120 of FIG. 1 and the user.

In another embodiment, configuration engine 218, authorization engine 222, and proxy engine 224 may be provided by specially programmed processors connected to bus 206, and the like. In yet another embodiment, tasks performed by configuration engine 218, authorization engine 222, and proxy engine 224 may be performed by distributed hardware in combination with software.

Memory 208 generally includes random access memory (RAM), but may also include read only memory (ROM). Memory 208 generally includes any operating system for controlling the operation of network device 200. The operating system may comprise an operating system such as UNIX, LINUX™, Windows™, and the like.

Memory 208 may include volatile and nonvolatile, removable and non-removable media implemented in any method or technology for storage of information, such as computer readable instructions, data structures, program modules or other data. RAM, ROM, EEPROM, flash memory or other memory technology may be employed to implement memory 208.

Storage device 216 may include CD-ROM, digital versatile disks (DVD) or other optical storage, magnetic cassettes, magnetic tape, magnetic disk storage or other magnetic storage devices, or any other medium that can store the information and that can be accessed by a computing device.

Network interface unit 214 is constructed for use with various communication protocols including the TCP/IP and UDP/IP protocol. Network interface unit 214 may include or interface with circuitry and components for transmitting packets, and the like, over a wired and/or wireless communications medium. Network interface unit 214 is sometimes referred to as a transceiver, Network Interface Card (NIC), and the like.

Network device 200 may also include an I/O interface 212 for communicating with external devices or users, such as administrator terminal 104 of FIG. 1, and the like.

General Operation

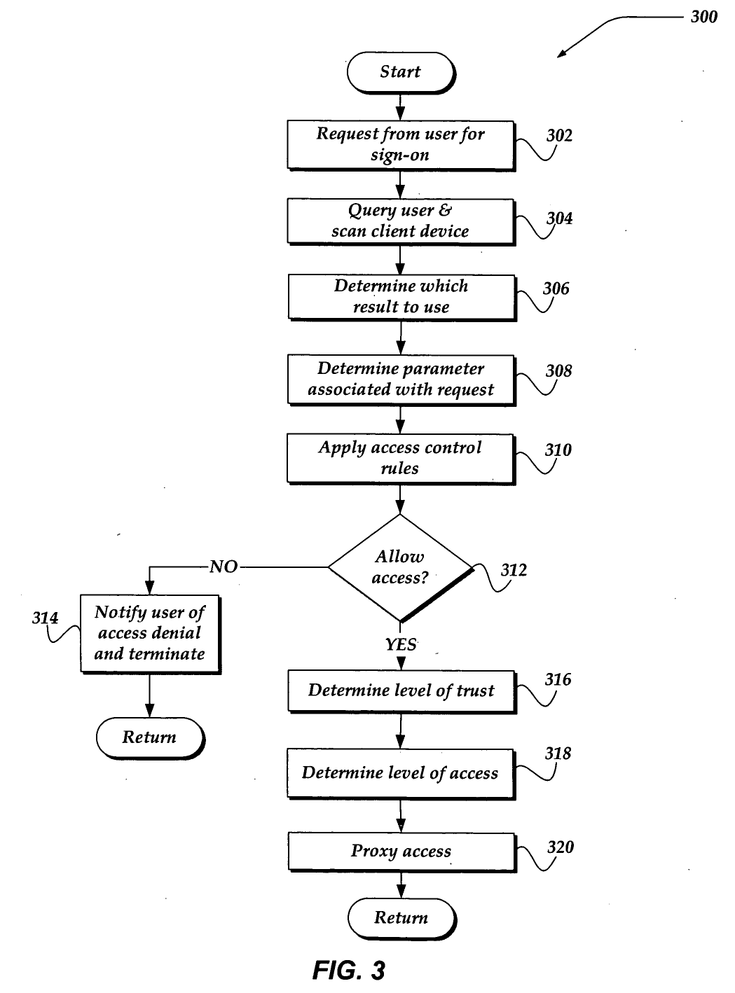

FIG. 3 illustrates a flow diagram generally showing one embodiment of a process for managing access to a resource over a network in accordance with the present invention. Process 300 may, for example, operate within resource controller 102 of FIG. 1.

Process 300 is one embodiment of a trust-based authorization framework. The framework comprises a resource controller configured to manage access to the resource, and a set of variables managed by the resource controller that define at least one parameter associated with a request from the user. The framework may further include a set of access control rules and a method of determining the variables and evaluating the user's request based, in part, on the access control rules and the values of variables.

As shown in FIG. 3, process 300 begins, after a start block, at block 302, where a request access to the resource is received from the user. The user may send the request from a client device, such as a computer within the enterprise network, a kiosk computer acting as a client device outside the enterprise network, and the like.

Processing then proceeds to block 304, where the user is queried and the client device associated with the request is scanned. The query of the user and the scan of the client device may be based, in part, on a stored user profile, and the like. The scan of the client device may be performed by downloading a scanner applet from the resource controller, such as a digitally signed JAVA applet, an executable program, a script, and the like.

Processing then proceeds to block 306, where the resource controller determines whether to use a result of the query, a result of the scan, a combination of the results from the query and the scan, previously stored information about the user, and the like.

Processing proceeds next to block 308. At block 308, a parameter associated with the user's request is determined based, in part, on the result selected at block 306. The parameter associated with the user's request may include, but is not limited to the user's identification, a membership in a group, a characteristic of the client device associated with the request, a type of request by the user. The characteristic of the client device may further comprise a network connection capability, a storage capacity, a processor speed, a geographic location of the client device, and the like. The type of request may be a request for sign-on, a request for access to a specific resource, and the like. If the request is for sign-on, determination of the parameter may include authentication of the user through self-authentication, authentication by a third party authentication server, and the like. The requested resource may include, but is not limited to, an output device, a storage device, an input device, a processing device. Block 308 is followed by block 310.

At block 310, at least one access control rule is applied to the parameter determined at block 308. The access control rules may be stored in configuration engine 218 of FIG. 2, for example. The access control rules may be configured by an administrator and may be updated as part of process 300. In one embodiment, an IP address of the client device may be evaluated in the format described above as the access rule is applied to the IP address. Processing then proceeds to decision block 312.

At block 312, a decision is made whether the user should be permitted access to the resource associated with the enterprise network or not, based, in part, on the application of the access control rule to the parameter. If the decision is affirmative, process proceeds to block 316. Otherwise, processing proceeds to block 314, where the user is notified of the denial of access and communication is terminated. Upon completion of block 314, processing returns to a calling process to perform other actions.

At block 316 a level of trust associated with the user's request is determined based, in part, on the application of the access rule to the parameter. The level of trust may be a global level of trust for the particular user, a specific level of trust for the particular user-client device combination, a specific level of trust particular to the requested resource, and the like. Although not shown, an affirmative decision at block 312 may also lead to a negotiation with a resource server on behalf of the user for access to the resource.

One embodiment for determining the trust level may be implemented in a variable format such as:

| Action | Condition |
|---|---|
| SET TRUST.LEVEL=”low” | IF (CLIENT_IP=10.1.2.0) OR |
| | AUTH_METHOD=”password”) |

Further steps associated with authorization for access to a resource may include “Actions” based, in part, on the determined trust level. One example of this may include:

| Action | Condition |
|---|---|
| ALLOW.PRINT | IF (TRUST.LEVEL=low) |

However, the invention is not limited to these examples, and other implementations may be employed, without departing from the spirit or scope of the invention. Processing then proceeds to decision block 318.

At block 318, a level of access to the resource is determined based on the level of trust determined at block 316. In one embodiment, the level of access may be determined based, in part, on the level of trust, and the user provided with that level of access. For example, a user may request a generalized access to printing resources on a network. The resource controller may provide access to a specific group of printers based, in part, on the geographic location of the user. In another embodiment, the level of access may have additional conditions, such as repeating the scan of the client device at predetermined intervals.

Processing then proceeds to block 320, where access to the resources is proxied to the client device associated with the request. Actions performed at block 320 may further involve updating network status information, providing specific connections to the user, and the like (not shown). Upon completion of block 320, processing returns to a calling process to perform other actions.

It will be understood that each block of the flowchart illustration, and combinations of blocks in the flowchart illustration of FIG. 3 may be implemented by a combination of hardware-based systems and software instructions. While the processes above are described referring to the embodiments of a user employing a client to access a network, the processes apply to any network device to be authorized. The software instructions may be executed by a processor to cause a series of operational steps to be performed by the processor to produce a computer implemented process such that the instructions, which execute on the processor, provide steps for implementing some or all of the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

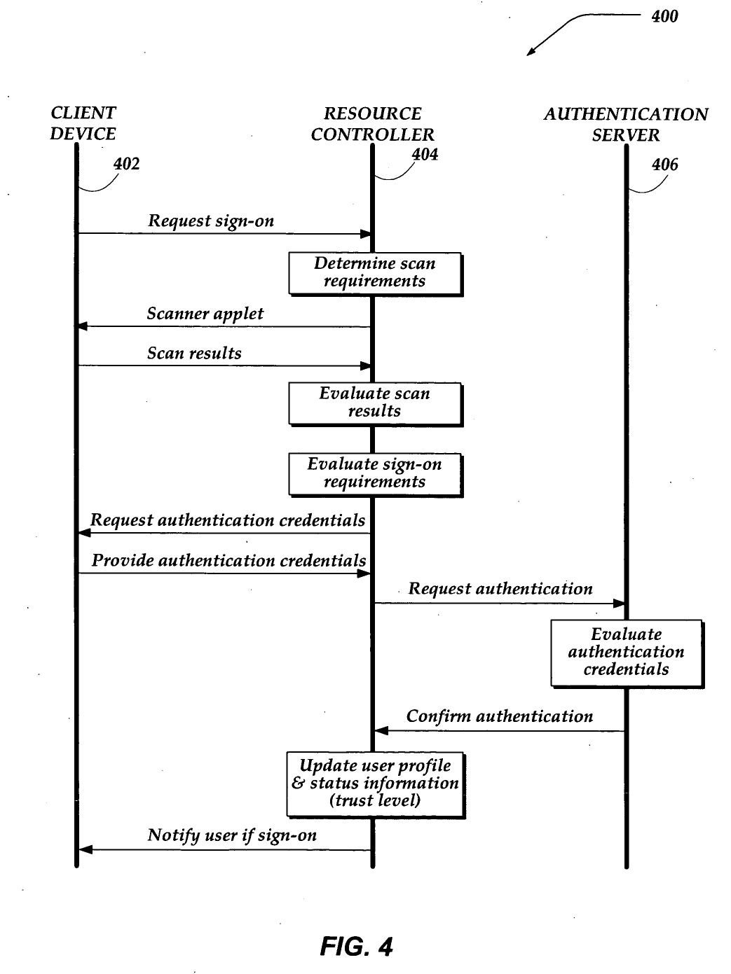

FIG. 4 illustrates one embodiment of a message flow diagram for a system substantially similar to the system shown in FIG. 1. FIG. 4 shows a resource controller configured to authorize a user employing a client device for sign-on with authentication by an authentication server. As shown in the diagram, message flow 500 includes client device 402, resource controller 404, and authentication server 406 across the top. Client device 402 and resource controller 404 may operate substantially similar to client device 106 and resource controller 102, respectively, of FIG. 1. Time may be viewed as flowing downward in the figure.

As shown in FIG. 4, an authorization process begins with client device 402 transmitting a request for sign-on. Resource controller 404 determines scan requirements based, in part, on the user's request and characteristics, such as a network address of the client device, an identity of the client software employed to access the resource controller, a group membership of the user, and the like. Resource controller 404 may download a scanner applet, such as a digitally signed JAVA applet, an executable program, a script, and the like, to client device 402. The download performs the security scan and scan results are transmitted back to resource controller 404. Resource controller 404 evaluates the scan results and the requirements for signing on. If the evaluation is affirmative, authentication credentials are requested from client device 402. Authentication credentials, provided by client device 402, are forwarded to authentication server 406. Authentication server 406 evaluates the credentials and confirms authentication to resource controller 404, if the result is affirmative. Upon confirmation of authentication, resource controller 404 may complete the sign-on process by updating a user profile and status information, and record the new information in a database. Updated user profile may include a trust level assigned to the user, and the like. Resource controller 404 may then send notification of sign-on authorization to client device 402.

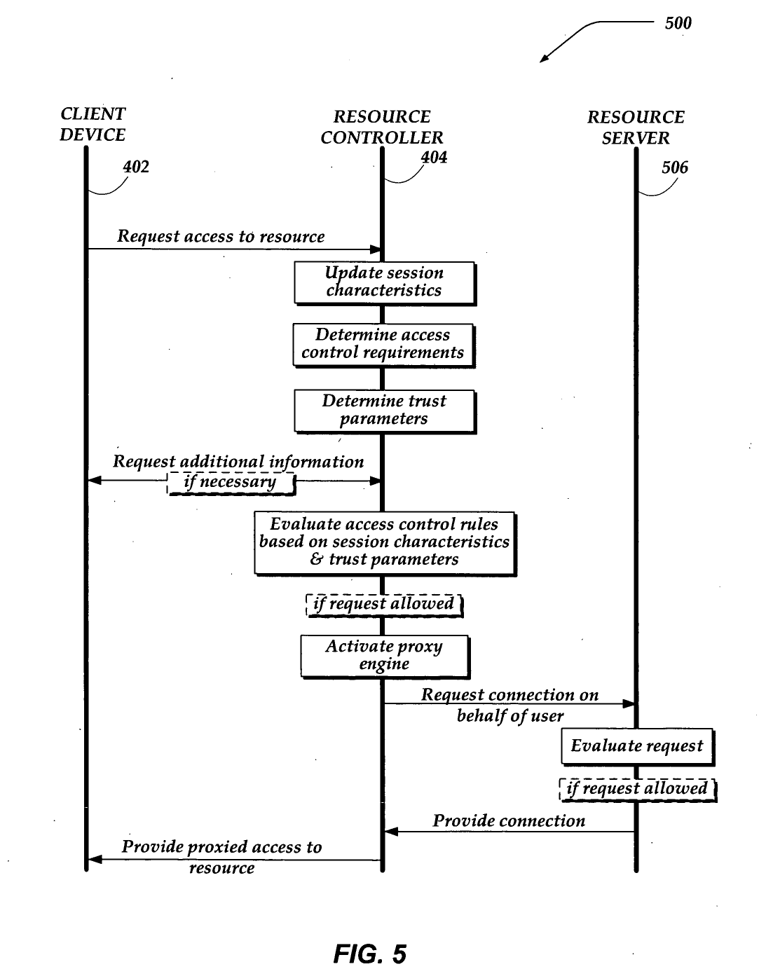

FIG. 5 illustrates another embodiment of a message flow diagram for a system substantially similar to the system shown in FIG. 1, where a network device authorizes a user employing a client device for access to a resource managed by a resource server. As shown in the diagram, message flow 600 includes client device 402, resource controller 404, and resource server 506 across the top. Time may be viewed as flowing downward in the figure.

As shown in FIG. 5, an authorization process begins with client device 402 transmitting a request for access to a resource. Upon receiving the request, resource controller 404 first updates session characteristics. Session characteristics may include a type of security employed by the client device, and the like. Resource controller 404 then determines access control requirements based, in part, on the user's request and previously stored user variables. Resource controller 404 may also determine trust parameters associated with the request. The trust parameters may include a level of trust assigned to the user for a particular request, communication type, security arrangement, and the like. Resource controller 404 may request additional information from the user, if necessary, to determine the trust parameters.

Following determination of trust parameters, resource controller 404 evaluate access control rules based, in part, on the session characteristics and the trust parameters. If the request is allowed, proxy engine is activated requesting connection to the resource from resource server 506 on behalf of the user. Resource server 506 evaluates the request. If the evaluation is affirmative, resource server 506 provides connection to the resource to resource controller 404, which in turn proxies the connection to client device 402 providing the requested access. However, the invention is not limited to resource controller 404 acting as a proxy, and another configuration may be employed. Any combination of actions performed by client device 402, resource controller 404, and authentication server 506 may be employed without departing from the spirit or scope of the invention.

It will be understood that each element of the message flow illustration, and combinations of elements in the message flow illustration of FIGS. 4 and 5, may be implemented by a combination of hardware-based systems and software instructions. While the message flows above are described referring to the embodiments of a user employing a client to access a network, the processes apply to any network device to be authorized. The software instructions may be executed by a processor to cause a series of operational steps to be performed by the processor to produce a computer implemented process such that the instructions, which execute on the processor, provide steps for implementing some or all of the actions specified in the message flow elements.

Accordingly, elements of the message flow illustration support combinations of means for performing the specified actions, combinations of steps for performing the specified actions and program instruction means for performing the specified actions. It will also be understood that each element of the message flow illustration, and combinations of elements in the message flow illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit or scope of the invention, the invention resides in the claims hereinafter appended.

We claim:

1. A method for managing access to a resource over a network, comprising:
receiving a request for access to the resource;
determining a parameter associated with the request based, in part, on querying a user and performing a scan of a client device associated with the request;
applying an access control rule based, in part, on the parameter to determine a level of trust; and
if the level of trust indicates permission for access to the resource, proxying the request towards the resource.

2. The method of claim 1, wherein a level of access to the resource is determined based, in part, on the level of trust, and includes at least one of restricted use of a resource, use of a particular resource, and global access to at least one resource.

3. The method of claim 1, wherein performing the scan of the client device further comprises at least one of determining a characteristic of the client device, and performing a security scan of the client device.

4. The method of claim 3, wherein the characteristic of the client device further comprises at least one of a network connection capability, a storage capacity, a processor speed, and a geographic location of the client device.

5. The method of claim 3, wherein another scan of the client device is performed at a predetermined interval after the request is proxied.

6. The method of claim 1, wherein the querying the user, and performing the scan of the client device is performed based, in part, on information included in a stored user profile.

7. The method of claim 1, wherein determining the parameter further comprises authenticating the user by employing at least one of self-authentication and authentication by a third party authentication server.

8. The method of claim 1 further comprising:
updating the access rule based, in part, on the parameter; and
storing the updated access rule for use in processing another request.

9. The method of claim 1 further comprising:
storing the updated trust level for use in processing another request.

10. A server for managing access to a resource over a network, comprising:
a transceiver configured to receive a request for access to the resource; and
a processor, coupled to the transceiver, configured to perform actions including:
determining a parameter associated with the request based, in part, querying the user, and performing a scan of a client device associated with the request;
applying an access control rule based, in part, on the parameter to determine a level of trust; and
if the level of trust indicates permission for access to the resource, instructing the transceiver to proxy the request towards the resource.

11. The server of claim 10 further comprising a storage device, wherein the parameter associated with the request is retrieved from the storage device.

12. The server of claim 10, wherein performing the scan of the client device further comprises at least one of determining a characteristic of the client device, and performing a security scan of the client device.

13. The server of claim 12, wherein the processor is configured to perform another security scan at a predetermined interval after the request is proxied.

14. The server of claim 10, wherein the processor is further configured to determine the parameter based, in part, on authenticating the user by employing at least one of self-authentication and authentication by a third party authentication server.

15. The server of claim 10, wherein the processor is further configured to determine a level of access to the resource based, in part, on the determined level of trust, and wherein the level of access includes at least one of restricted use of a resource, use of a particular resource, and global access to at least one resource.

16. The server of claim 10, wherein the processor is further configured to store at least one of the parameter and the trust level for use in processing another request.

17. A system for managing access to a resource over a network, comprising:
a server including:
a transceiver configured to receive a request for access to the resource; and
a processor, coupled to the transceiver, configured to perform actions including:
determining a parameter associated with the request based, in part, querying the user, and performing a scan of a client device associated with the request;
applying an access control rule based, in part, on the parameter to determine a level of trust; and
if the level of trust indicates permission for access to the resource, instructing the transceiver to proxy the request towards the resource; and
the client device including:
a transceiver configured to perform actions including:
requesting access to the resource from a server over the network; and
a processor configured to perform actions including:
if a query is received from the server, responding to the query; and
if an instruction for a security scan is received from the server, performing the security scan, and reporting a result of the security scan to the server.

18. A modulated data signal having computer executable instructions embodied thereon for managing access to a resource over a network, the modulated data signal comprising the actions of:
transferring a request for access to the resource from a client device associated with the request to a server;
transferring an instruction for a query and a scan of a client device from the server to the client device;
enabling a determination of a parameter associated with the request based, in part, on the response;
enabling an application of an access control rule based, in part, on the parameter to determine a level of trust; and
if the level of trust indicates permission for access to the resource, transferring a proxy connection to the resource from the server to the client device.

19. An apparatus for managing access to a resource over a network, comprising:
a means for receiving a request the resource;
a means for querying the user and performing a scan of a client device associated with the request;
a means for determining a parameter associated with the request based, in part, on a result of querying the user and performing the scan of the client device;
a means for applying an access control rule based, in part, on the parameter to determine a level of trust; and
if the level of trust indicates permission for access to the resource, a means for proxying the request towards the resource.
